(19) United States
(12) Patent Application Publication
(10) Pub. No.: US 2014/0272512 A1
(43) Pub. Date: Sep. 18, 2014

(54) Redox Flow Battery System Configuration For Minimizing Shunt Currents

(71) Applicant: EnerVault Corporation, Sunnyvale, CA (US)

(72) Inventors: Jay E. SHA, Moutain View, CA (US); Bruce LIN, Mountain View, CA (US)

(73) Assignee: EnerVault Corporation, Sunnyvale, CA (US)

(21) Appl. No.: 14/215,589

(22) Filed: Mar. 17, 2014

Related U.S. Application Data
(60) Provisional application No. 61/798,415, filed on Mar. 15, 2013.

(51) Int. Cl. H01M 8/20

(52) U.S. Cl. CPC H01M 8/20
USPC 429/105

(57) ABSTRACT

Various embodiments of redox flow battery stack assemblies may include a plurality of multiple-block strings, where each string may include a plurality of reaction blocks connected in electrical series and in fluidic parallel. Various embodiments provide configurations and systems for mitigating or substantially reducing shunt currents in common electrolyte conduits.

### CROSS-REFERENCE TO RELATED APPLICATIONS

This application claims the benefit of U.S. Provisional Patent Application Ser. No. 61/798,415, filed Mar. 15, 2013 and entitled, “Redox Flow Battery System Configuration for Minimizing Shunt Currents,” the contents of which are incorporated herein by reference in their entirety.

### STATEMENT OF FEDERALLY FUNDED RESEARCH

Inventions included in this patent application were made with Government support under DE-OE0000225 “Recovery Act—Flow Battery Solution for Smart Grid Renewable Energy Applications” awarded by the U.S. Department of Energy (DOE). The Government has certain rights in these inventions.

### FIELD

This invention generally relates to redox flow battery systems and more particularly to a system of electrical connections for elements of a redox flow battery system.

### BRIEF DESCRIPTION OF THE DRAWINGS

The novel features of the invention are set forth with particularity in the claims that follow. A better understanding of the features and advantages of the systems and methods herein will be obtained by reference to the following detailed description that sets forth illustrative embodiments, in which the principles of the invention are utilized, and the accompanying drawings of which:

FIG. 1 is a schematic diagram illustrating a redox flow battery stack assembly having multi-block strings.

FIG. 2 is a schematic diagram illustrating a redox flow battery stack assembly having multi-block strings, including shunt current resistors.

FIG. 3 is a schematic diagram illustrating a redox flow battery stack assembly having multi-block strings with strings physically separated into groups of blocks that may operate over the same voltage range.

FIG. 4 is a schematic diagram further illustrating a redox flow battery stack assembly having multi-block strings with strings physically separated into groups of blocks that may operate over the same voltage range.

### DESCRIPTION

The various embodiments will be described in detail with reference to the accompanying drawings. References made to particular examples and implementations are for illustrative purposes, and are not intended to limit the scope of the invention or the claims. Various examples of systems and methods are described below for assembling redox flow battery systems configured for high voltage, high power and high capacity while minimizing electric shunt currents in fluid electrolyte flow channels.

Redox flow battery systems store electrical energy in liquid electrolytes pumped through reaction stacks. Redox flow batteries and other electrochemical processing systems often use bipolar stacks in order to combine the benefit of multiple individual reaction cells into a larger package. A bipolar stack may generally include a plurality of individual electrochemical reaction cells arranged back-to-back, such that a positive end plate of one cell may also serves as the negative end plate for the adjacent cell. Hence, such a plate is typically referred to as a “bipolar plate.” A bipolar stack effectively joins the individual cells in electrical series with one another. Therefore, the electric potential of a bipolar stack will be the sum of the potentials of all of the individual cells. In some cases, it may also be desirable to join two or more bipolar stacks (also referred to herein as “cell modules” or “modules”) in electrical series to further increase electric potential of a system. Furthermore, in some cases, it may be desirable to join groups of bipolar stacks in electrical series with one another, while also joining at least some of the stacks fluidically in parallel.

Multiple cell modules may be arranged in fluidic cascades as described for example in U.S. patent application Ser. No. 12/986,892, titled “Cascade Redox Flow Battery Systems,” the contents of which are incorporated herein by reference in their entirety. Cascade arrangements provide several benefits, one of which is the ability to efficiently charge or discharge electrolytes through an entire charge cycle (which may typically be less than 100% of the available state of charge) in a single fluidic pass through the reaction stack. Even if not arranged in cascades, flow battery stacks may be configured to charge or discharge electrolytes in a single fluid pass through the reaction stack.

Thus, in embodiments, the blocks described below may comprise non-cascade flow battery cell blocks or reaction stacks configured to complete a charge and/or discharge cycle in a single fluidic pass through the system. In order to achieve high voltages for grid-scale storage, many cell blocks in a desired configuration may be connected in electrical series. In further embodiments, the systems described herein may also be applied to recirculating flow battery systems in which liquid electrolytes are circulated between a reaction stack and one or more tanks several times, charging or discharging through a portion of a total charge range during each pass through the reaction stack.

The schematic diagrams in FIG. 1, FIG. 2, FIG. 3, and FIG. 4 illustrate flow battery stack assemblies 100, 200, 300, 400 with fluid electrolyte flow lines indicated by thick solid lines (e.g., 40, 42, 44. 46), electrical connections indicated by thin solid lines (e.g., 20, 22), and selected shunt currents represented by thin dotted lines (e.g., 60). In embodiments, each block 10 in the diagrams may represent a physical grouping of reaction cells which may be bundled into modules, bipolar stacks, cascades and/or other configurations as needed for a particular application.

In embodiments, each block 10 may represent a collection of cell modules arranged into cascade stages such that, within a single cascade, electrolyte flows out of cells making up a first stage and into cells making up a second stage (proceeding to third and subsequent stages if present), increasing or decreasing the electrolyte state-of-charge by a discrete amount in each stage. For simplicity, the details of cascade configurations and operation are not shown here, but cascades may include any number of stages and any number of cells as needed.

In alternative embodiments, each block 10 may represent a non-cascade collection of flow battery reaction cells. In such embodiments, the non-cascade cells within a block may be arranged in any fluidic configuration relative to one another as needed for a particular application. Also for simplicity, only a single electrolyte flow path is indicated, although some flow battery systems may use two flowing fluid electrolytes. The flow of electrolyte in flow battery systems may also be reversible for charging and discharging in embodiments. Thus, schematic indications of electrolyte flow direction in the drawings may indicate either a charging or a discharging process. Further, while certain example voltages are provided for illustration, systems may be designed and constructed for any voltage ranges as desired. Thus, the invention is not limited to either the absolute or the relative voltage values indicated herein.

FIG. 1 illustrates embodiments including an example configuration of a multi-block flow battery stack assembly 100 including three “strings”. For example, a first string may be defined as including the blocks between the electrical terminals at 22 and 24, a second string may be defined as including the blocks between electrical terminals at 26 and 28, and a third string may be defined as including the blocks between electrical terminals 32 and 34. Each “string” may be made up of multiple blocks 10 connected to one another in electrical series.

As shown in FIG. 1, the blocks 10 may be arranged in fluidic parallel such that a fluid electrolyte may be directed through an inlet 40, distributed by an inlet manifold 42, into the blocks 10. In some cases, as shown in FIG. 1, electrolyte may be simultaneously directed from a common conduit and/or manifold into multiple blocks 10 which may be part of different strings. After passing through the blocks 10, electrolytes may be directed into a common outlet 46 by an outlet manifold 44.

In various embodiments, the inlet manifold 42 and the outlet manifold 44 may be configured using any suitable combination of structures, such as various lengths of pipe with branch connectors, or a unitary or multi-component manifold assembly.

As shown in FIG. 1, the stack assembly 100 may include blocks 10 configured to operate between different electric potentials. For example, blocks of type “circle 1” (\textcircled{1}) 51 may operate between 0V and 150V, blocks of type “circle 2” (\textcircled{2}) 52 may operate between 150V and 300V, blocks of type “circle 3” (\textcircled{3}) 53 may operate from 300V to 450V, and blocks of type “circle 4” (\textcircled{4}) 54 may operate between 450V and 600V. A string may generally comprise at least one block configured to operate at each potential range. Thus, in the illustrated example, a string may include one or more blocks of each of the types (\textcircled{1}) 51, (\textcircled{2}) 52, (\textcircled{3}) 53, and (\textcircled{4}) 54. In embodiments, the three strings of FIG. 1 may be electrically connected to one another in parallel in order to expand the power of the overall stack assembly.

Although FIG. 1 illustrates three strings having four blocks 10 each, a flow battery stack assembly using the principals disclosed may be arranged into any number of strings having any number of blocks 10. Such details may be determined based on requirements of a particular application. Similarly, while the blocks 10 shown are each labeled as having a 150V potential difference, alternative cell blocks may be configured with any electrical characteristics as needed for a particular application.

As an example, if each block 10 is configured to support a potential difference of 150V, and if blocks are arranged into strings configured to produce 600V, very large shunt currents may tend to result due to the high voltage differences between electrolytes flowing in a common manifold 42, 44. For example, a voltage difference of 600 volts may exist between points A & B in FIG. 1, causing substantial shunt currents 60 in the electrolyte manifold section 62 joining those points. Shunt currents of varying magnitude may also tend to flow in other electrolyte conduit sections joining blocks at different potentials. The magnitude of a shunt current between any two points in an electrolyte conduit may be proportional to the voltage between those two points and the electrical resistance through the electrolyte conduit may be as dictated by Ohm's law (conduits may typically be made of an electrically non-conductive material, so electrical resistance may also be a function of the electrolyte composition).

FIG. 2 illustrates embodiments of a redox flow battery stack assembly including multi-block strings and shunt current resistors for limiting or eliminating shunt currents 60 in a stack assembly 200. Stack assembly 200 may have an arrangement similar to that of stack assembly 100 of FIG. 1. In such embodiments, shunt current resistors 64, such as mechanical shunt current resistors, may be positioned in electrolyte flow lines 42, 44 between blocks 10, which may have substantial potential differences. Mechanical shunt current resistors 64 may include any of the structures shown and described in U.S. patent application Ser. No. 13/312,802, titled “Shunt Current Resistors For Flow Battery Systems,” which is incorporated herein by reference. Some shunt current resistors may include mechanical devices configured to create an electrical discontinuity while allowing for continuous fluid flow. Other shunt current resistors may include flow conduits with small cross-sectional area or long enough paths to cause the inherent resistance of the electrolyte to resist or eliminate the shunt currents. Other configurations are also possible. Adding shunt current resistors 64 to all conduits between blocks 10 (or only between points of high potential difference) may be feasible. However, such a configuration is likely to add substantial cost and complexity to the system, and may also increase electrolyte flow resistance, resulting in additional pumping power requirements and/or other increased costs.

FIG. 3 illustrates embodiments of a stack assembly 300 in which strings may be separated such that blocks 10 are grouped by voltage level. In some cases, blocks 10 operating across common voltages may be physically or otherwise grouped together in order to reduce shunt currents. For example, type “1” (\textcircled{1}) blocks 51 configured to operate from 0 to 150 volts may be grouped together as a first group, and a second group of type “2” (\textcircled{2}) 52 blocks configured to operate between 150V and 300V may be located adjacent the first group. Similarly, type “3” (\textcircled{3}) blocks 53 may be arranged as a third group, and type “4” (\textcircled{4}) blocks 54 may be arranged as a fourth group. As a result, the only shunt currents in the common electrolyte conduits 42, 44 are those between the groups of blocks of a common type. Using the example voltage values shown, the largest voltage difference between any two points (e.g., points A & B) in a common electrolyte conduit may be only 150V. Thus, arranging blocks by common voltages may substantially reduce shunt currents in the common electrolyte conduits 42, 44.

Shunt currents between groups of blocks 10 may be further mitigated by adding active or passive shunt current resistors and/or long conduit sections between groups of blocks 10. For example, conduit sections of two to three meters between block groups may be sufficient to reduce shunt currents between the groups to an acceptable level. Flow battery electrolytes may generally have a measurable electrical resistance per unit length of a conduit of known cross-sectional area. A conduit length sufficient to reduce shunt currents to a desired level may be calculated using Ohm's law and the resistance per unit length. In some cases, shunt currents may be reduced as a percentage of stack output power. For example, less than about 1% of total stack power may be sufficiently low. In other cases, shunt currents may be reduced to as close to zero as practical while meeting other constraints.

In various embodiments, blocks operating at common voltage levels may be grouped together by physically locating them together, or simply by fluidically coupling the blocks to minimize conduit segments with large voltage drops. While physically co-locating blocks of a common type may be beneficial for reducing material costs, such co-location may not be strictly necessary. Additionally, while the blocks in a common group are shown electrically joined to one another in parallel, the blocks may alternatively be arranged into separate strings of one or more block of each type per string.

FIG. 4 illustrates embodiments of a multi-block flow battery stack assembly 400 with multiple block strings arranged such that strings may be physically separated into groups of blocks that may operate over the same voltage range. In embodiments, some groups are physically reversed to reduce the number of electrolyte conduit sections through which shunt currents may flow. In the embodiment of FIG. 4, the blocks 10 may be grouped by voltage level similarly to the system of FIG. 3. However, in the system of FIG. 4, the blocks of the second 52 and fourth 54 groups may be configured such that their low voltage end (e.g., 150V and 450V, respectively) is adjacent the electrolyte outlet conduit 44. Therefore, the blocks of the second 52 and fourth 54 groups may be arranged such electrolytes enter those blocks at their high voltage end, while electrolytes enter the blocks of the first 51 and third 53 groups at their low voltage ends.

In embodiments, such configurations may be achieved by physically reversing the type “2” (\textcircled{2}) 52 and type “4” (\textcircled{4}) 54 blocks relative to the type “1”(\textcircled{1}) 51 and type “3” (\textcircled{3}) 53 blocks. Alternatively, the type “2” (\textcircled{2}) 52 and type “4” (\textcircled{4}) 54 blocks may be physically arranged identically to the type “1” (\textcircled{1}) 51 and type “3” (\textcircled{3}) 53 blocks, while fluidically connecting the type “2” (\textcircled{2}) 52 and type “4” (\textcircled{4}) 54 blocks to achieve the same result.

In this configuration, the voltage drop in the outlet conduit 44 between the first and second block groups 51, 52 is zero. The voltage drop is also zero in the outlet conduit 44 between the third and fourth block groups 53, 54 and in the inlet conduit 42 between the second and third groups 52, 53. Beneficially, no shunt currents will flow in conduit segments connecting groups at equal potentials (e.g., no shunt currents 60 will flow between points C & D). This arrangement may further reduce the sections of conduit through which shunt currents 60 may flow (such as between points A & B). In embodiments, active or passive shunt current resistors 64 may be used in these three positions. Alternatively, the length of conduit sections in which shunt currents 60 may potentially flow may be increased until the resistance of the electrolyte is sufficient that shunt currents are substantially reduced. For example, conduit sections of two to three meters between block groups may be sufficient to reduce shunt currents between the groups to an acceptable level.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Various modifications to the above embodiments will be readily apparent to those skilled in the art, and the generic principles defined herein may be applied to other embodiments without departing from the spirit or scope of the invention. Thus, it is intended that the scope of the present invention herein disclosed should not be limited by the particular disclosed embodiments described above, but should be determined only by a fair reading of the claims that follow.

In particular, materials and manufacturing techniques may be employed as within the level of those with skill in the relevant art. Furthermore, reference to a singular item, includes the possibility that there are plural of the same items present. More specifically, as used herein and in the appended claims, the singular forms “a,” “and,” “said,” and “the” include plural referents unless the context clearly dictates otherwise. As used herein, unless explicitly stated otherwise, the term “or” is inclusive of all presented alternatives, and means essentially the same as the commonly used phrase “and/or.” It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs.

What is claimed is:

1. A redox flow battery stack assembly comprising:
an electrolyte inlet conduit and an electrolyte outlet conduit;
a plurality of flow battery cell blocks fluidically connected in parallel with one another between the inlet conduit and the outlet conduit;
wherein the cell blocks are arranged into groups, each group having a plurality of cell blocks configured to operate across a common voltage range, and wherein the groups are joined to the electrolyte inlet conduit and the electrolyte outlet conduit such that shunt currents may only flow in the inlet conduit or the outlet conduit between adjacent groups.

2. The assembly of claim 1, wherein each cell block comprises a cascade with a plurality of cells arranged in fluidic series.

3. The assembly of claim 1, wherein a first group of a pair of adjacent groups has a low voltage end joined to the inlet conduit, and a second group of the pair of adjacent groups has a low voltage end joined to the outlet conduit.

4. The assembly of claim 1, further comprising shunt resisting structures in the inlet conduit or the outlet conduit configured for limiting shunt currents in the inlet conduit or the outlet conduit.

5. The assembly of claim 4, wherein the shunt resisting structures are long conduit segments.

6. The assembly of claim 4, wherein the shunt resisting structures are active shunt current resistors.
